(19) United States
(12) Patent Application Publication
(10) Pub. No.: US 2015/0216021 A1
(43) Pub. Date: Jul. 30, 2015

(54) Synchronized Speed Bump Illumination System and Method

(71) Applicant: Aervoe Industries, Inc., Gardnerville, MA (US)

(72) Inventors: Michael Joseph Bennett, Zephry Cove, NV (US); Robert Haelsig, Minden, NV (US)

(73) Assignee: Aervoe Industries, Inc., Gardnerville, MA (US)

(21) Appl. No.: 14/163,221

(22) Filed: Jan. 24, 2014

(51) Int. Cl. H05B 37/02; E01F 9/047; F21V 8/00; F21V 23/00; H05B 33/08; F21V 33/00; F21V 23/04

(52) U.S. Cl. CPC H05B 37/0272; F21V 33/00; E01F 9/047; F21V 23/0435; F21V 23/007; H05B 33/0845; G02B 6/0005; F21W 2111/02

(57) ABSTRACT

A synchronized speed bump illumination system and method is provided that includes powered LEDs that may be seen by individuals at night and in low light conditions, or during the day to increase visibility and direct a driver's attention to the speed bump. The speed bump system comprises sections each with a housing having a flat bottom surface and an elevated top surface to form the bump. A plurality of LEDs provides illumination to light windows embedded in the top surface of the sections. A wireless remote control is used to simultaneously transmit signals to an independent circuit in each section so that the groupings of LEDs in each section provide a predefined illumination pattern among the sections.

### COPYRIGHT NOTICE

Portions of this disclosure contain material in which copyright is claimed by the applicant. The applicant has no objection to the copying of this material in the course of making copies of the application file or any patents that may issue on the application, but all other rights whatsoever in the copyrighted material are reserved.

### BACKGROUND

Speed bumps are used in a variety of situations to slow vehicles. The speed bumps may be either permanently affixed to the road surface or placed temporarily for a limited time period. Permanent speed bumps are used on roads and in parking lots where there is a tendency for drivers to exceed the recommended speed limit, particularly around schools, in parking lots and in neighborhoods where children or pedestrians are regularly present. Situations where temporary speed bumps are commonly used may include, but are not limited to locations such as the scene of an emergency or accident where first responders are present, parking lots, school crossings, airport traffic control and other pedestrian crossings for an event such as a sporting event, a fair or other event where people must cross a road or parking area but where a permanent speed bump is not required or desirable.

To date, permanent and temporary speed bumps are known in the prior art. An example of a temporary speed bump configuration is shown in FIG. 1A. Speed bump 100 is formed of a group of hinged plastic molded sections 105. The number of sections incorporated in speed bump 100 varies and may be increased or decreased depending on the width of the road surface on which speed bump 100 is to be used. Each section 105 is flat on the bottom side 110 to contact the road with a double angled top side 115 to create a bump which vehicle tires contact as they pass over the bump. Each section 105 may have approximate dimensions, for example, of ten inches in width, fifteen feet in length or a length appropriate to stretch across the road, and one inch in height at its peak and sloping down on either side. However, it should be understood that different sized bump sections may be used depending on the application and the speed at which it is appropriate for a vehicle to ride over the bump without damaging the vehicle or causing discomfort to occupants as the vehicle passes over speed bump 100.

A stackable configuration of speed bump 100 is shown in FIG. 1B where speed bump 100 is shown with interleaving sections 120 that are hinged on either side to a section 105. When not in use, speed bump 100 may be stacked and stored in a carrying case 125a such as a soft shell nylon bag shaped to match speed bump 100 as shown in FIGS. 1B-1C.

In an alternative embodiment, sections 105 may be hinged directly together or fused together with flexible material between sections 105 so that speed bump 100 that may be rolled up. An example of a roll-up configuration of speed bump 100 is shown in FIG. 1D where speed bump 100 is shown with hinges. When rolled up, speed bump 100 may be stored in a case such as a soft shell nylon bag 125b shaped to match speed bump 100 as shown in FIG. 1E.

In many cases, speed bump 100 is formed of sections 105 that are manufactured in bright colors such as yellow or orange. Alternatively, sections 105 may be configured in alternating colors such as yellow and black. In addition, sections 105 may include reflective material applied to the top surface so that when vehicle headlights are directed at the speed bump, they are easily visible to a driver in darkness or low light. The reflective material may be in different shapes to show direction such as an arrow 130.

While prior art speed bumps currently function to slow the speed of vehicles in situations where emergency responders or pedestrian traffic is present on a temporary basis, the speed bumps of the prior art are difficult to see at night and in low light. Therefore, it is desirable to provide speed bumps that are more clearly lighted for use in dark and low light conditions. The present invention incorporates electrically operated light emitting diodes (“LEDs”) to provide an energy efficient light source. In addition, the present invention includes remote operation of the LEDs such that the LEDs may be individually embedded within portions of a speed bump to be synchronized without the need to electrically couple the LEDs in different speed bump portions or sections.

### BRIEF DESCRIPTION OF THE DRAWINGS

FIGS. 1A-1E show a variety of views of a prior art temporary speed bump;

FIG. 2 is a perspective view of a temporary speed bump incorporating electrically powered LEDs;

FIG. 3 is a perspective view of a section of a temporary speed bump incorporating electrically powered LEDs;

FIG. 4 is a top view of hinged sections of a temporary speed bump incorporating electrically powered LEDs;

FIG. 5 is a first bottom perspective view of a speed bump section incorporating electrically powered LEDs;

FIG. 6 is a second bottom perspective view of a speed bump section incorporating electrically powered LEDs;

FIG. 7 is a top down sectional view of a section of a temporary speed bump incorporating electrically powered LEDs;

FIG. 8 is a block diagram of an electrical circuit of a speed bump incorporating electrically powered LEDs;

FIG. 9 is a block diagram representing the communication between a speed bump incorporating electrically powered LEDs and a remote control;

FIG. 10 is a perspective view of a remote control for controlling a speed bump incorporating electrically powered LEDs; and

FIG. 11 is a block diagram of an electrical circuit of a remote control for controlling electrically powered LEDs in a speed bump.

### DETAILED DESCRIPTION

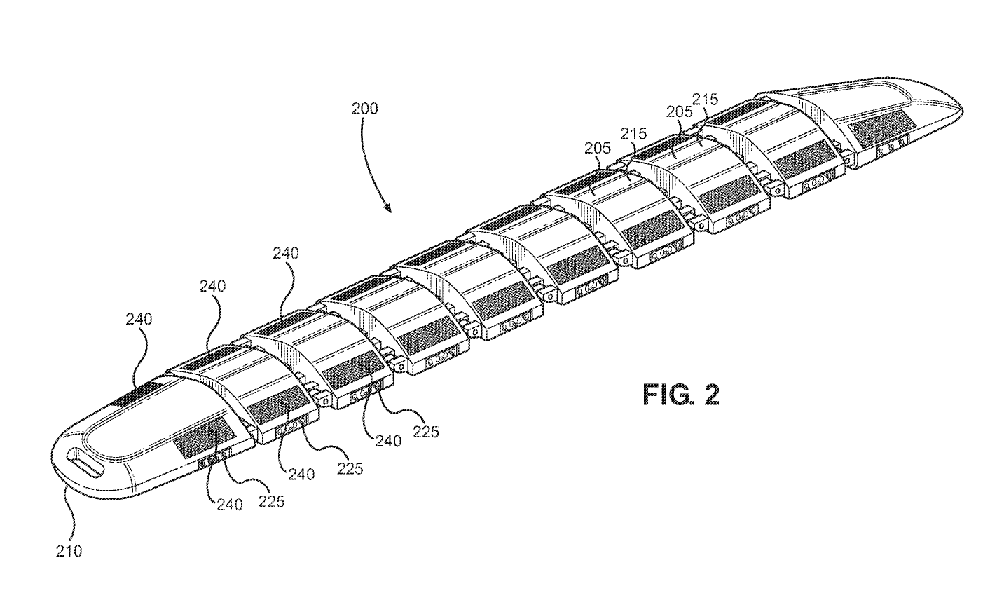

The present invention will now be described more fully with reference to the accompanying drawings. It should be understood that the invention may be embodied in many different forms and should not be construed as limited to the embodiments set forth herein. Throughout FIGS. 2-11, like elements of the invention are referred to by the same reference numerals for consistency purposes.

FIG. 2 is a perspective view of a temporary speed bump 200 incorporating electrically powered LEDs. As can be seen in FIG. 2, speed bump 200 is formed of a group of hinged plastic molded sections 205. The number of sections incorporated in speed bump 200 varies and may be increased or decreased depending on the width of the road surface on which speed bump 200 is to be used. Each section 205 is flat on the bottom side 210 to contact the road with a double angled top surface 215 to create a bump which vehicle tires contact as they pass over the bump. Each section 205 may have approximate dimensions, for example, of ten inches in width, fifteen feet in length or another length that corresponds to the width of a road surface, and one inch in height at its peak and sloping down at either side. However, it should be understood that different sized bump sections may be used depending on the application and the speed at which it is appropriate for a vehicle to ride over the bump without damaging the vehicle or causing discomfort to occupants as the vehicle passes over the speed bump.

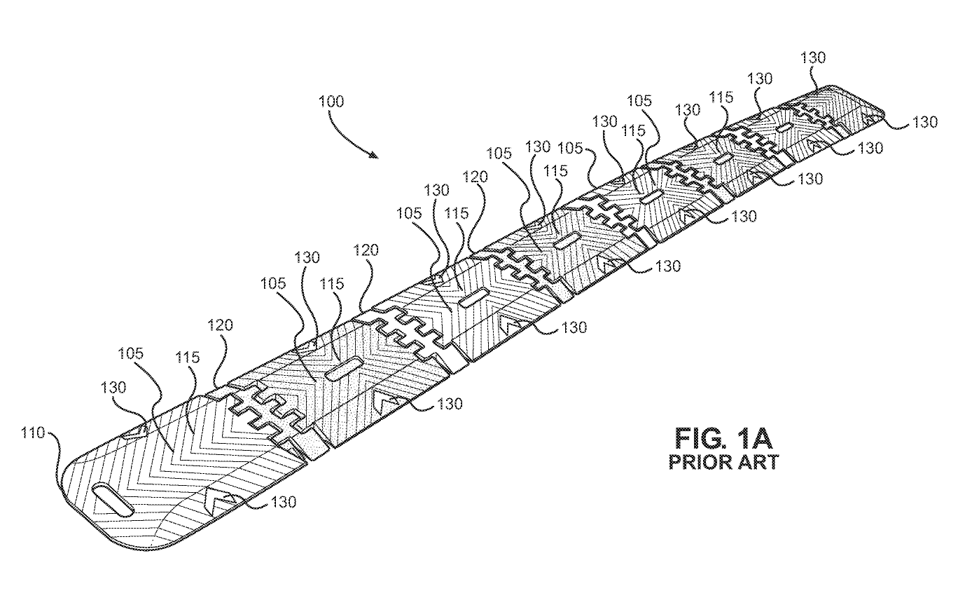

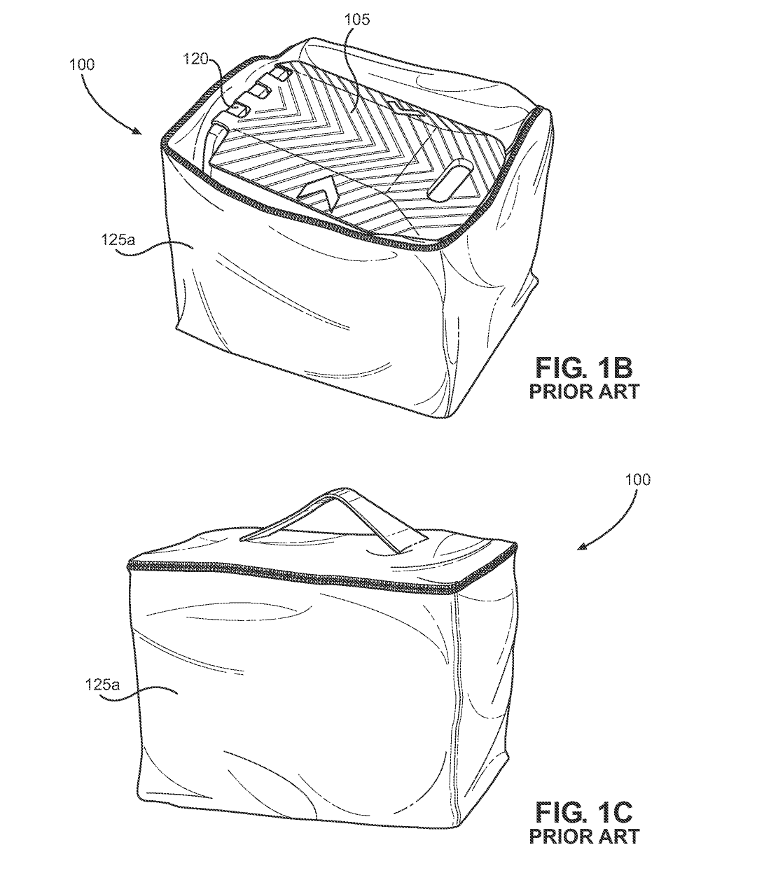

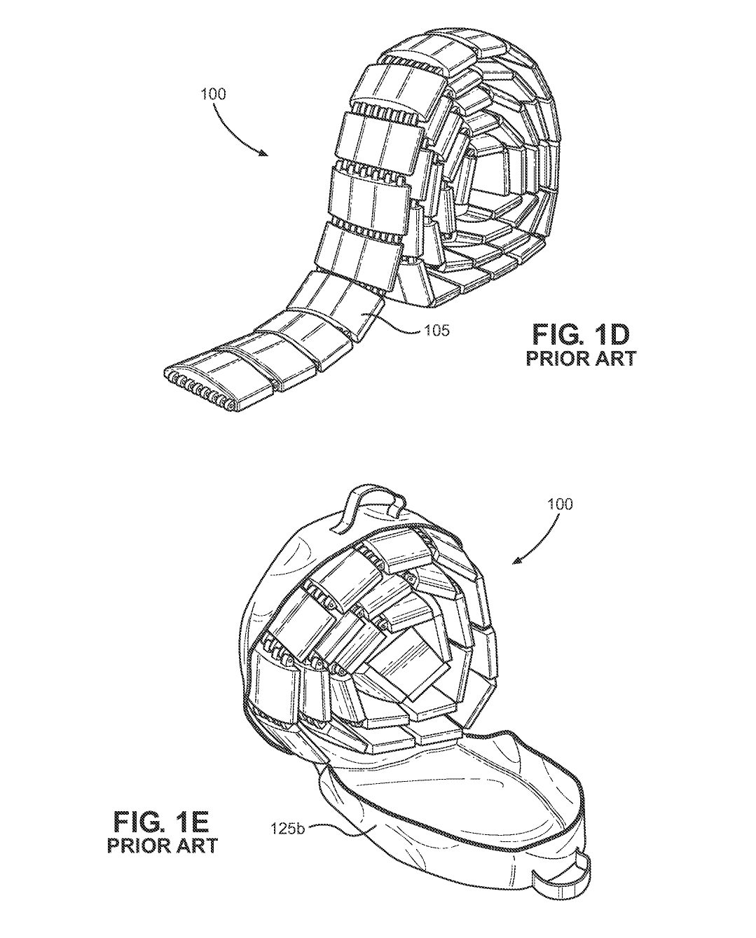

A stackable configuration of speed bump 200 is shown in FIG. 2 where speed bump sections 205 are hinged on either side to an adjacent section 205. When not in use, speed bump 200 may be stacked and stored in a carrying case similar to that shown in FIG. 1 such as a soft shell nylon bag shaped to match speed bump 200. Alternatively, and instead of implementing speed bump section 205 being directly hinged to an adjacent section, an interleaving section (not shown), that is similar to the structure of speed bump 100 may be used. Or, a flexible material such as polypropylene (manufactured, for example, by companies such as DuPont or Dow Chemical) may be fused to the sides of adjacent sections to hold them together.

Speed bump 200 may be formed of sections 205 that are manufactured in bright colors such as yellow or orange. Alternatively, sections 205 may be configured in alternating colors such as yellow and black. In addition, sections 205 include embedded light emitting diodes (“LEDs”) that provide illumination to one or more light windows or light strips 225 in a portion of upper surface 215 that is oriented so that it can be seen by an oncoming driver or pedestrian. The upper surface 215 may include a sloped portion or a vertical portion on either side. The LEDs may illuminate or flash in one or more patterns to make speed bump 200 readily visible when approached in darkness or low light. Light windows are clear plastic inserts through which a light source inside of section 205 may pass through and be visible from the outside. Sections 205 are formed of injected molded plastic such as polypropylene manufactured by DuPont or Dow Chemical. The plastic must be hard enough and durable enough to withstand extreme weather conditions and the weight of vehicles of all types continuously passing over sections 205.

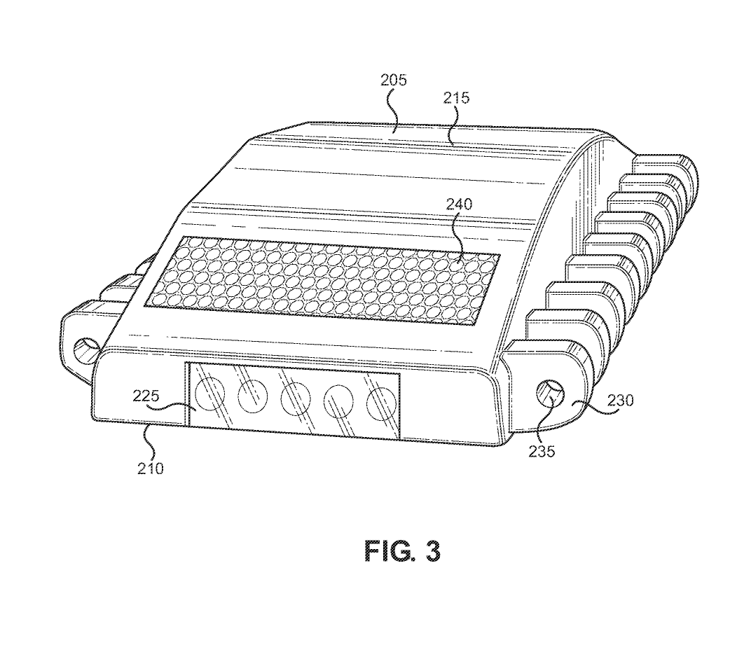

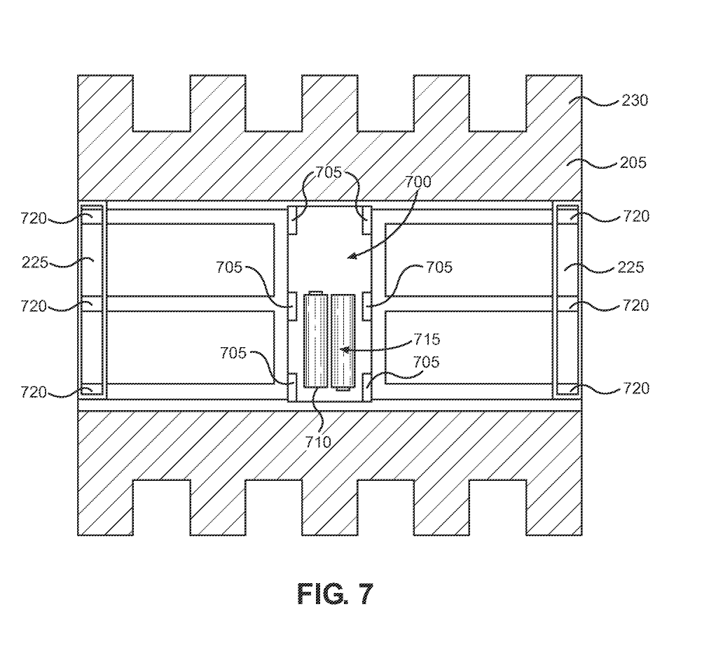

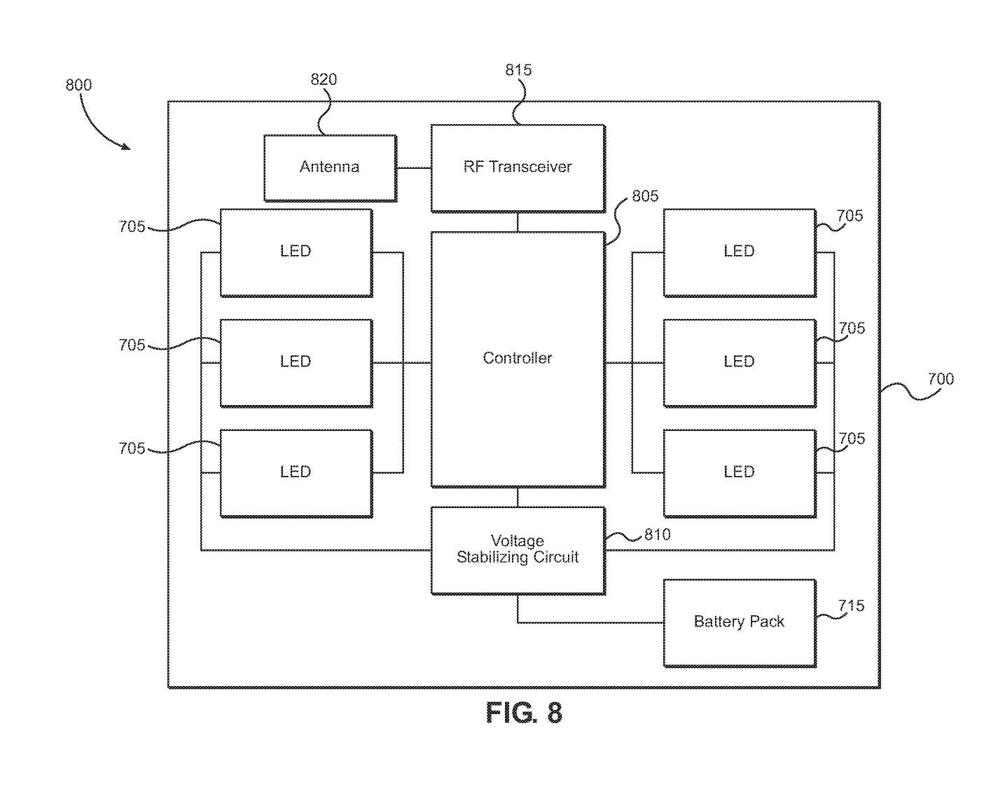

FIG. 3 is a perspective view of a single section 205 of temporary speed bump 200 incorporating a light window 225 that is illuminated by one or more electrically powered LEDs (see FIGS. 7-8). A set of protruding elements 230 line either side of section 205 so that an interleaving section 220 or an adjacent section can be attached. Attachment of adjacent sections is accomplished by lining up protruding elements 230 on section 205 with the protruding elements on an interleaving section or an adjacent section. An elongated pin, made of metal, molded plastic or another suitable material, is then inserted through hole 235 in each of elongated sections 230. The pin may be maintained in place by screwing it into the last elongated section, or the pin may have a cap at one end and be threaded at the other end so that a nut can be attached to it to hold the sections together. Reflective material in various shapes and sizes 240 may also be affixed to top surface 215 of sections 205 to further increase visibility of speed bump 200.

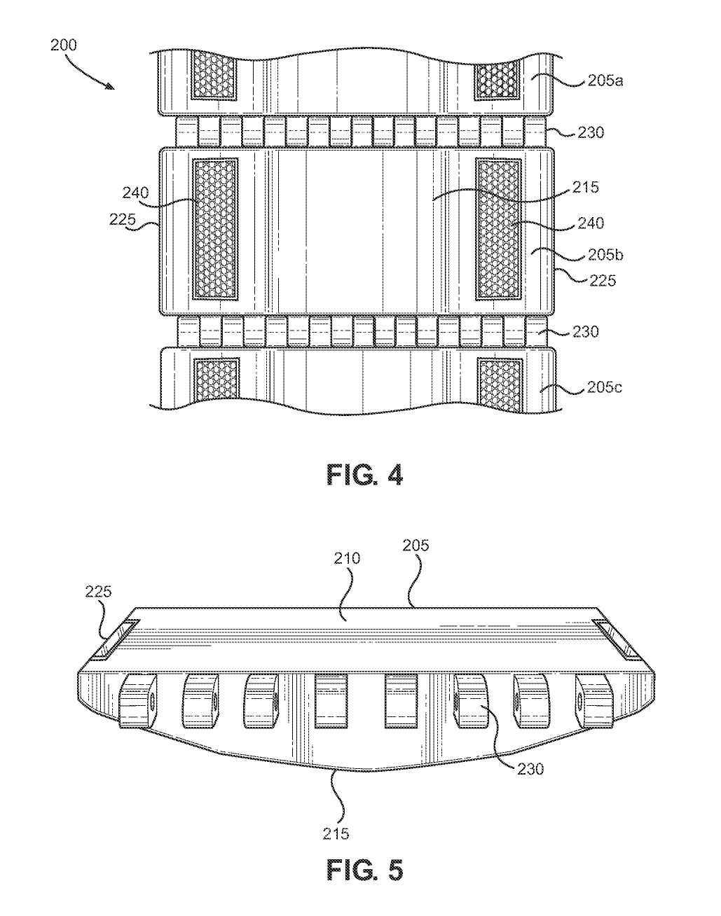

FIG. 4 is a top view of three sections 205a-c of temporary speed bump 200 attached to each other and incorporating electrically powered LEDs. Each section 205 includes a pair of light strips 225 embedded in opposing sides of angled top surface 215. In the embodiment shown in FIG. 4, light strips 225 are embedded in a vertically configured sidewall that is considered part of upper surface 215 of section 205 for purposes of this description.

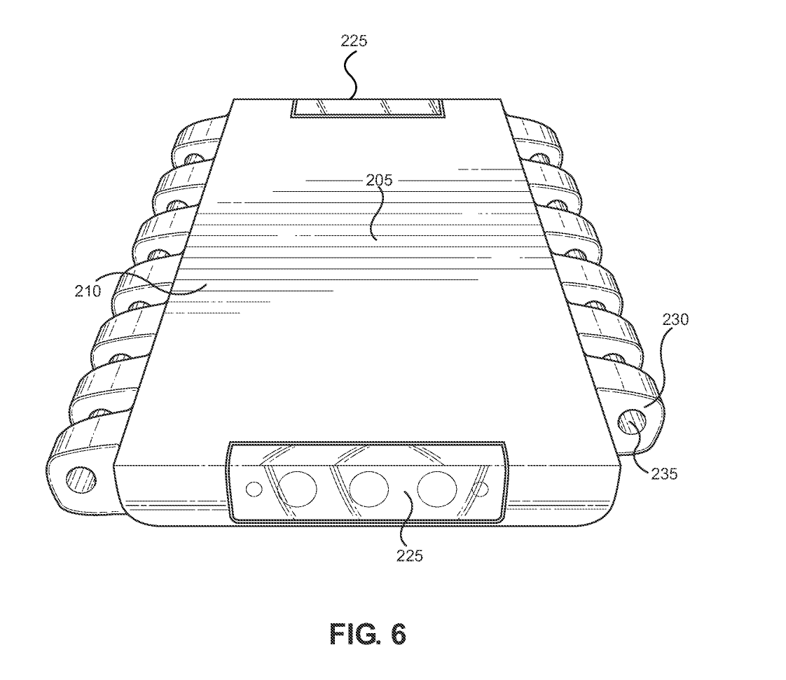

FIG. 5 and FIG. 6 show two perspective views of a bottom 210 of section 205 of temporary speed bump 200 incorporating light strips 225. It should be understood, that light strips 225 may be just as easily embedded in a sloped sidewall of upper surface 215 or in any other portion of upper surface 215, including the area where reflective material 240 is shown in the figures. For purposes of this description, the vertical sidewall portion where light strip 225 is shown FIG. 3 is considered part of upper surface 215.

FIG. 7 is a top down sectional view of section 205 of temporary speed bump 200 incorporating light strips 225. In the embodiment shown in FIG. 7, a printed circuit board 700 is embedded within section 205 and includes six LEDs 705 that are, for example, super bright surface mount technology (“SMT”) LEDs. LEDs 705 are mounted on printed circuit board 700 that is embedded within the housing of section 205. Circuit board 700 has circuitry (see FIG. 8) for controlling LEDs 705 and includes a battery pack 710 that may, for example, be powered by 2 AA batteries 715 or a similar power source. To bring the light produced by LEDs 705 to light strip 225 where it can exit section 205 and be visible, light pipes or channels 720 are provided within the housing of section 205 when housing 205 is manufactured. Light pipes 720 may be formed, for example, of polycarbonate 94V-0 clear or 3025N2 clear manufactured by Samyang Corporation.

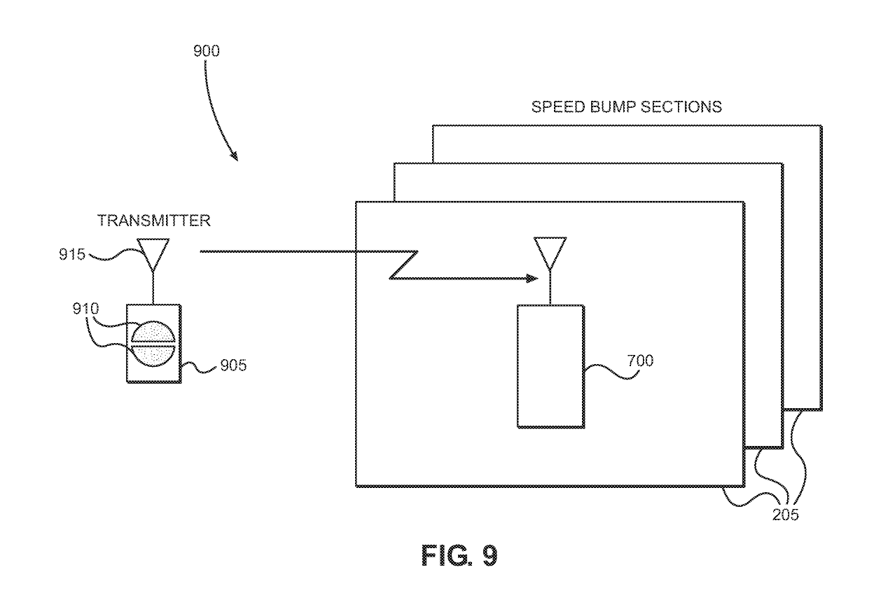

FIG. 8 is a block diagram 800 of electrical circuit 700 of speed bump 200 incorporating LEDs 705. A controller 805 is typically a microprocessor or dedicated controller that is at the center of circuit 700. Controller 805 controls the operation of a number of LEDs 705, for example six LEDs, in section 205. Battery pack 715 provides power to controller 805 and LEDs 705 through a voltage stabilizing circuit 810 of a type that is well known in the art. Controller 810 is also connected to an RF transceiver 815. RF transceiver 815 is configured to receive signals from a remote control (see FIG. 9). Transceiver 815 may also send signals for the purpose of confirming receipt of signals through antenna 820.

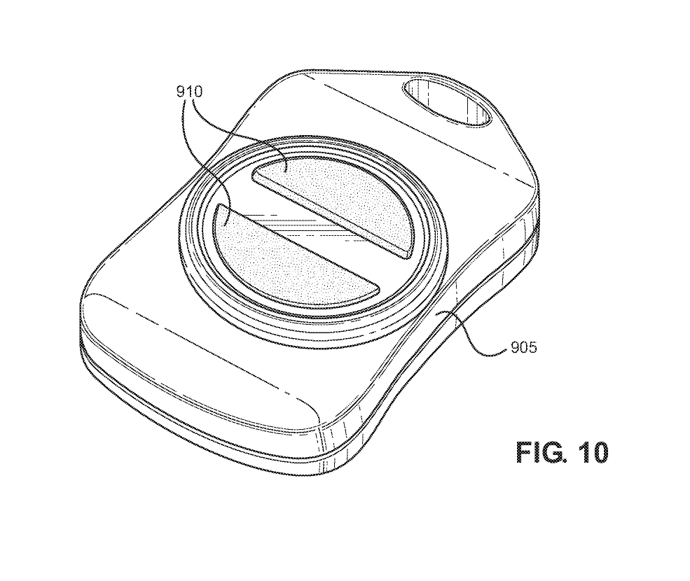

FIG. 9 is a block diagram 900 representing the communication between one or more sections 205 of speed bump 200 incorporating LEDs 705 and a remote control transmitter 905. FIG. 10 is a perspective view of remote control transmitter 905 for controlling LEDs 705 in sections 205 of speed bump 200. Transmitter 905 includes buttons 910 mounted on controller 905. Buttons 905 are programmed or may be programmed to transmit one or more signals to be received by transceivers 815 in circuit 700 in sections 205 simultaneously. A transmitter antenna 915 is used to transmit the signal from remote control transmitter 905 where it is received by antenna 820 and provided to transceivers 815. The signals are passed from transceivers 815 to controllers 805 in each section 205. In this way, controllers 805 for all sections 205 in speed bump 200 receive signals simultaneously and can synchronize the illuminating of LEDs 705 among all sections 205 in speed bump 200. The synchronization of LEDs 705 among multiple sections 205 allows a user to instruct speed bump 200 using transmitter 905 to provide signals that indicate a coordinated illumination pattern across sections 205.

For example, a first signal (or set of signals) to sections 205 may provide that all LEDs 705 be illuminated and stay illuminated until a second signal is received to turn off LEDs 705.

Alternatively, all LEDs in sections 205 may be instructed to flash at a pre-defined frequency so that all LEDs 705 flash simultaneously. In yet another example of an illumination pattern, sections 205 may be instructed to flash in sequential order so that LEDs 705 on any given section are flashed on and off following the flashing of LEDs 705 in the adjacent section so that an illumination pattern goes back and forth across speed bump 200. Other illumination patterns may also be predefined or programmed by a user into remote control transmitter 905 and transmitted to sections 205 by a user by pressing buttons 910.

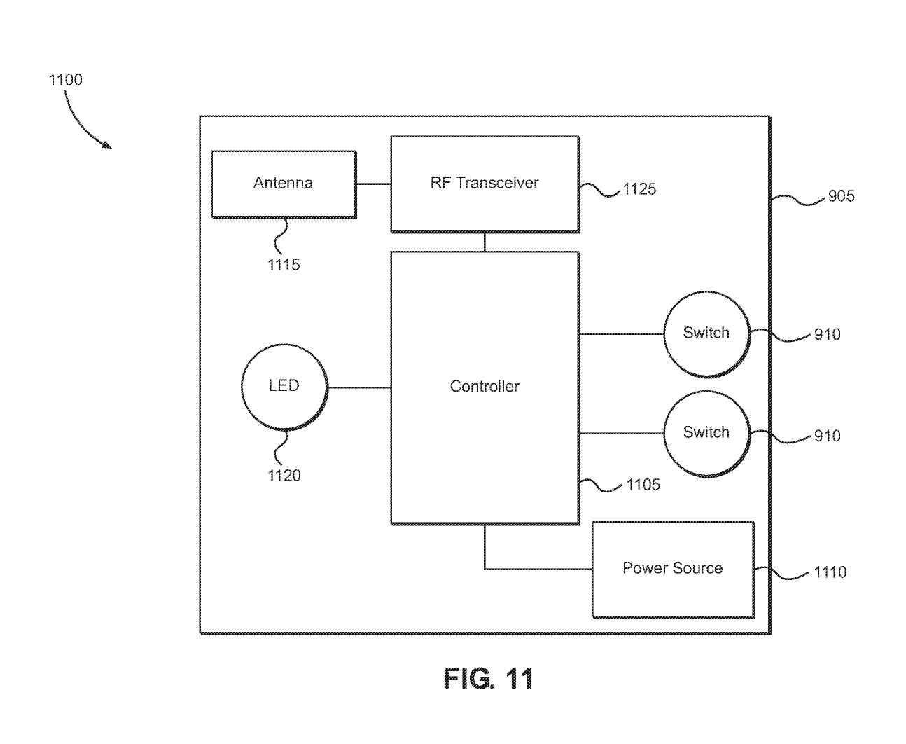

FIG. 11 is a block diagram of an electrical circuit 1100 of remote control 905 for controlling electrically powered LEDs 705 in sections 225 of speed bump 200. A controller 1105 controls the operation of remote 905. A power source 1110 powers circuit 1100 and is typically in the form of a battery. An antenna 1115 is used to transmit wireless signals to (and receive wireless signals from) sections 205 of speed bump 200. Switches 910 are depressed by a user to perform operations on remote 900. Circuit 1100 includes a LED 1120 that is located on the outside of remote 905 and indicates to the user that switches 910 have been depressed to send a signal from remote 905 to section 205. Controller 810 is also connected to an RF transceiver 1125. RF transceiver 1125 is configured to receive signals from remote control 905. Transceiver 1125 may also send signals for the purpose of confirming receipt of signals through antenna 1115.

The foregoing invention has been described in accordance with the relevant legal standards, thus the description is exemplary rather than limiting in nature. Variations and modifications to the disclosed embodiment may become apparent to those skilled in the art and fall within the scope of the invention. Accordingly the scope of legal protection afforded this invention can only be determined with reference to the claims. For example, it should be understood that while the invention has been described with respect to a set of LEDs that are positioned on a circuit board and that provide illumination to a light strip through a light pipe, it is also possible to place one or more LEDs at a location behind the light windows at the surface of the section housing eliminating the need to provide a light pipe or channel between the LED and the light strip. In addition, although the shape of the top surface of the housing has been described as sloped, it could also be flat with squared off sides and the light strips being embedded in the top or the sides. The upper surface of sections 205 could also take on other shapes with the light strips placed in or on the upper surface in a way that is proximate to the upper surface so that they are visible by an oncoming driver or pedestrian. The flash patterns and timing are also subject to designer choice and may include any number of different illumination timing patterns.

What is claimed is:

1. An electrically illuminated speed bump system comprising:
at least two sections that are connected to form a speed bump, each section comprising:
a housing having a bottom surface, an upper surface and a side with at least one connecting element;
at least one light window positioned proximate to the upper surface;
at least one LED enclosed in the housing and positioned to provide illumination to the at least one light window;
a section circuit encased in the housing that is in electrical connection with the at least one LED and that comprises:
a controller;
a section antenna;
a transceiver that receives signals in wireless form from the section antenna that are provided to the controller; and
a power source that provides power to the section circuit; and
a remote control comprising:
a remote control antenna;
a remote control controller;
at least one switch having a first position and a second position; and
a remote control circuit that transmits wireless signals through the remote control antenna when the at least one switch is in a first position and is idle when the at least on switch is in a second position; and
wherein upon selecting the first position on the switch, the remote control instructs each of the at least two sections to illuminate the LEDs.

2. The system of claim 1 wherein the remote control is programmed to transmit at least two different illumination patterns among the LEDs in the sections which are communicated to the LEDs during operation of the speed bump system.

3. The system of claim 1 wherein the connecting element comprises at least one protrusion with a hole that is interleaved with at least one protrusion of an adjacent section where two sections are connected, and wherein a pin is inserted through the hole in each interleaved protrusion.

4. The system of claim 1 further comprising an interleaving section having a housing with a connecting element on each side, each connecting element comprising at least one protrusion with a hole that is interleaved with a section, wherein the interleaving section is positioned between two adjacent sections and a pin is inserted through the hole in each interleaved protrusion on each side.

5. The system of claim 1 wherein the connecting element is formed of a flexible material that is connected between opposing sides of two adjacent sections.

6. The system of claim 1 further comprising at least one light pipe in the housing having a first end positioned proximate to at least one LED and a second end terminating proximate to the light window.

7. The system of claim 1 wherein the at least one LED is positioned behind the at least one light window such that when the at least one LED is turned on, light passes directly from the at least one LED through the at least one light window.

8. A method of illuminating a speed bump having at least two sections that are configured to form a speed bump, wherein the illumination pattern among the sections is synchronized, comprising:
providing a first section and a second section each comprising:
a housing having a bottom surface, an upper surface and a side with at least one connecting element;
at least one light window proximate to the upper surface;
at least one LED enclosed in the housing and positioned to provide illumination to the at least one light window;
a section circuit encased in the housing that is in electrical connection with the at least one LED and that comprises:
a controller;
a section antenna;
a transceiver that transmits signals received from the controller through the section antenna in wireless form, and receives signals in wireless form from the section antenna that are provided to the controller; and
a power source that provides power to the section circuit;
providing a remote control comprising:
a remote control antenna;
a remote control controller;
at least one switch having a first position and a second position; and
a remote control circuit that transmits wireless signals through the remote control antenna when the at least one switch is in a first position and is idle when the at least on switch is in a second position;
selecting the first position on the switch; and
transmitting an instruction from the remote control to each of the at least two sections to illuminate the LEDs.

9. The method of claim 8 further comprising programming the remote control to transmit signals representing at least two different illumination patterns for the LEDs among the sections.

10. The method of claim 8 wherein the connecting element comprises at least one protrusion with a hole that is interleaved with at least one protrusion of an adjacent section where two sections are connected, and inserting a pin through the hole in each interleaved protrusion.

11. The method of claim 8 comprising:
providing an interleaving section having a housing with a connecting element on each side, each connecting element comprising at least one protrusion with a hole that is interleaved with a section;
positioning the interleaving section between two adjacent sections; and
inserting a pin through the hole in each interleaved protrusion on each side.

12. The method of claim 8 wherein the connecting element is formed of a flexible material that is connected between opposing sides of two adjacent sections.

13. The method of claim 8 further comprising providing at least one light pipe in the housing having a first end positioned proximate to at least one LED and a second end proximate to the light window.

14. The method of claim 8 wherein the at least one LED is positioned behind the at least one light window such that when the at least one LED is turned on, light passes directly from the at least one LED through the at least one light window.

15. An electrically illuminated speed bump system comprising:
a speed bump housing comprising:
a bottom surface and an upper surface that is elevated above a roadway surface;
a plurality of light windows proximate to the upper surface and spaced apart from each other along a length of the housing;
a plurality of LEDs enclosed in the housing and positioned to provide illumination to the plurality of light windows in at least two subgroups;
at least two speed bump circuits encased in the housing, each speed bump circuit in electrical connection with one subgroup of the plurality of LEDs, and that comprises:
a controller;
an antenna;
a transceiver that receives signals in wireless form from the section antenna that are provided to the controller; and
a power source that provides power to the section circuit; and
a remote control comprising:
a remote control antenna;
a remote control controller;
at least one switch having a first position and a second position; and
a remote control circuit that transmits wireless signals through the remote control antenna when the at least one switch is in a first position and is idle when the at least on switch is in a second position; and
wherein upon selecting the first position on the switch, the remote control instructs each of the at least two sections to illuminate the LEDs.

16. The system of claim 15 wherein the remote control is programmed to transmit at least two different illumination patterns among the subgroups of LEDs which are communicated to the LEDs during operation of the speed bump system.

17. The system of claim 15 further comprising at least one light pipe in the housing having a first end positioned proximate to at least one LED and a second end proximate to the light window.

18. The system of claim 15 wherein the at least one LED is positioned behind the at least one light window such that when the at least one LED is turned on, light passes directly from the at least one LED through the at least one light window.
